(19) United States
(12) Patent Application Publication
(10) Pub. No.: US 2003/0158734 A1
(43) Pub. Date: Aug. 21, 2003

(54) TEXT TO SPEECH CONVERSION USING WORD CONCATENATION

(76) Inventor: BRIAN CRUICKSHANK, OAKVILLE (CA)

Correspondence Address: DOCKET CLERK, P.O. DRAWER 800889, DALLAS, TX, 75380, US

(21) Appl. No.: 09/464,076

(22) Filed: Dec. 16, 1999

(51) Int. Cl. G10L 13/08

(52) U.S. Cl. 704/260

(57) ABSTRACT

The present invention is directed to converting text to speech such that a more natural sounding speech output is generated compared to most currently available text to speech engines. The invention does so in a computationally efficient manner that is suitable for supporting hundreds of channels on a single application server. It provides a vocabulary of words that covers over 95% of words typically found in e-mails, with the remaining words, names, etc. being covered by a second text to speech engine. The second text to speech engine can be a more computationally intensive speech synthesis engine without much impact to the overall computational efficiency of the text to speech system, since it only needs to handle the remaining 5% of the words. The invention can integrate the words generated by the second text to speech engine seamlessly with the words generated by the first engine. Another benefit of the invention is that creating new ‘voices’ for the text to speech engine is simple and inexpensive. Allowing voices to be created that match pre-recorded “voice prompts” in a voice messaging system, for example.

### FIELD OF THE INVENTION

The present invention relates to conversion of text to speech, in particular, conversion of text to speech using word concatenation.

### BACKGROUND OF THE INVENTION

As the use of electronic mail (e-mail) has proliferated, a need to be able to review a text only message when away from a text based terminal has increased. For instance, one could review e-mail messages over a telephone while driving. Text to speech technology has been developed to serve this need. Fundamentally, text to speech functions as a pipeline that converts text into pulse code modulated (PCM) digital audio. The elements, or modules, of the pipeline are: text normalisation; homograph disambiguation; word pronunciation; prosody; and concatenation of wave segments. Current types of text to speech engines differ primarily in the word pronunciation component. Such types include formant synthesis, vocal tract modelling (typically using Linear Predictive Coding), and phoneme/diphone/allophone concatenation.

A vocal tract (the throat from the vocal cords to the lips) has certain major resonant frequencies. These frequencies change as the configuration of the vocal tract changes, like when we produce different vowel sounds. These resonant peaks in the vocal tract transfer function (or frequency response) are known as “formants”. From the formant positions, the ear is able to differentiate one speech sound from another. In a formant synthesis text to speech system, a synthesizer simulates the human speech production mechanism using digital oscillators, noise sources, and filters (formant resonators) similar to an electronic music synthesizer.

Linear Predictive Coding (LPC) may be used to analyse a stored speech signal by estimating the formants, removing their effects from the speech signal, and estimating the intensity and frequency of the remaining buzz. The process of removing the formants is called inverse filtering, and the remaining signal is called the residue. The numbers which describe the formants and the residue can then be stored. An LPC text to speech system synthesises a speech signal by reversing the process: using appropriate portions of the stored residue to create a source signal, using appropriate ones of the stored formants to create a filter (which represents the tube), and running the source signal through the filter to result in speech.

A phoneme is a unit in a phonetic representation of a language. Each phoneme corresponds to a set of similar speech sounds which are perceived to be a single distinctive sound in the language. A diphone comprises two adjacent phonemes. As the same phoneme can have different acoustic distributions when pronounced in different contexts, an allophone is defined as an acoustic manifestation of a phoneme in a particular context. A concatenation text to speech system synthesises a speech signal by concatenating phoneme/diphone/allophone building blocks together to form a complete word.

In general, the speech created by these types of text to speech engines sounds artificial and machine-like, either due to the tonality of the speech (LPC, formant synthesis) or due to discontinuities between the speech elements that are being concatenated to form words. These impairments often make the meaning of the created speech difficult for people to understand when they first encounter a system of one of these types. Over time, people can learn to interpret the speech that is generated by these types of system but many applications exist for which a learning period is not practical.

Systems that use concatenation of pre-recorded voice prompts are well known, have been used for years in voice messaging systems, and offer significantly better voice quality than the above types of text to speech engines. However, these systems generally have very restrictive vocabularies with which to generate speech, such as the time of day, number of messages in a mailbox, fixed passages such as help prompts, etc. which mean that they are not suitable for reading random text such as that found in e-mails.

RealSpeak™, from Lernout & Hauspie Speech Products N.V. of Ypres, Belgium, promises improved voice quality by using concatenation of “a whole range of speech segments such as diphones, syllables, and also larger phoneme sequences”. A drawback of this technology is that it requires significant computational and memory resources to implement. This requirement limits the number of simultaneous channels of text to speech that may be supported by a single PC server. This limitation increases the cost associated with providing text to speech to a large user population. As well, the process used for creating a new voice takes over two months, making it more expensive to customise a voice to make it sound like other pre-recorded voice prompts in a system.

### SUMMARY OF THE INVENTION

The present invention is directed to converting text to speech such that a more natural sounding speech output is generated compared to currently available text to speech engines. The invention does so in a computationally efficient manner that is suitable for supporting hundreds of channels on a single application server. Speech samples corresponding to a vocabulary of words that covers a large percentage of words typically found in e-mail messages is provided, with the remaining words, names, etc. being converted to speech samples by a second text to speech engine.

In accordance with an aspect of the present invention there is provided a method of converting text to speech including receiving a list of textual units, where each textual unit is one of a word, a prefix or a suffix, and for each textual unit, locating an associated speech sample in a memory and appending the associated speech sample to an output signal. In another aspect of the invention a text to speech converter is provided to carry out this method. In a further aspect of the invention a software medium permits a general purpose computer to carry out the method.

In accordance with a further aspect of the present invention there is provided a method of pre-processing a text file including receiving a text file, parsing the text file into textual units, where each parsed textual unit is one of a word, a prefix or a suffix, and for each one of the parsed textual units, if the one of the parsed textual units corresponds to a stored textual unit in a vocabulary of textual units, adding the stored textual unit to a list.

In accordance with still further aspect of the present invention there is provided a text to speech conversion system including a text file pre-processor operable to receive a text file, parse the text file into textual units, where each parsed textual unit is one of a word, a prefix or a suffix and for each one of the parsed textual units, if the one of the parsed textual units corresponds to a stored textual unit in a vocabulary of textual units, add the stored textual unit to a list. The conversion system further includes a textual unit processor operable to receive a list of textual units, where each textual unit is one of a word, a prefix or a suffix, for each textual unit, locate an associated speech sample in a memory and append the associated speech sample to an output signal.

In accordance with another aspect of the present invention there is provided a computer data signal embodied in a carrier wave comprising a textual unit and a speech sample associated with the textual unit, where the textual unit is one of a word, a prefix or a suffix.

In accordance with still further aspect of the present invention there is provided a data structure comprising a field for a textual unit and a field for a speech sample associated with the textual unit, where the textual unit is one of a word, a prefix or a suffix.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In the figures which illustrate example embodiments of this invention:

FIG. 1 schematically illustrates a text messaging system with text to speech capability;

FIG. 2 schematically illustrates a text to speech engine in accordance with an embodiment of the present invention;

FIG. 3 illustrates, in a flow diagram, list creation method steps followed by a text preprocessor in an embodiment of the present invention;

FIG. 4 illustrates, in a flow diagram, text to speech conversion method steps followed by a concatenation engine in an embodiment of the present invention; and

FIG. 5 illustrates a data structure associated with a textual unit in an embodiment of the present invention.

### DETAILED DESCRIPTION OF THE PREFERRED EMBODIMENTS

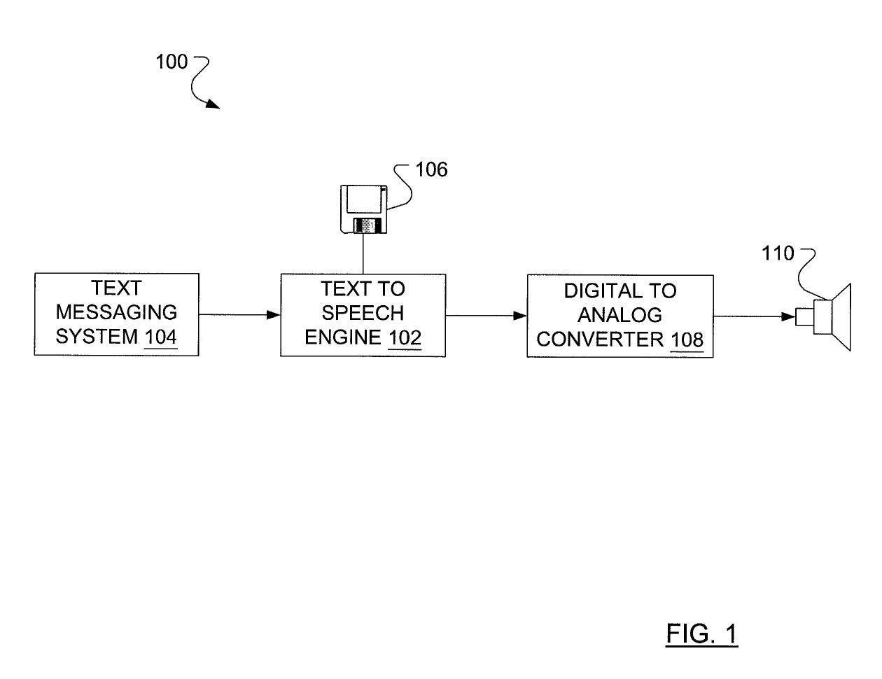

In FIG. 1 is illustrated a system in which the present invention may be useful. A messaging system 104 is connected to a text to speech engine 102 loaded with text to speech software for executing the method of this invention from a software medium 106. Software medium 106 may be a disk, a tape, a chip or a random access memory containing a file downloaded from a remote source. Digital output from text to speech engine 102 may be passed to a digital to analog converter (DAC) 108 from which an output analog signal can drive a speaker 110. In one instance, speaker 110 and DAC 108 are part of a telephone used to review e-mail messages on messaging system 104.

In overview, a set of utterances of root words, prefixes and suffixes are pre-recorded into speech samples. The speech samples are processed and stored. When required, an audio signal is generated from supplied text by parsing the supplied text into a list of textual units, using each textual unit to find, in memory, a corresponding speech sample, concatenating speech samples to form speech units, and concatenating these speech units to form a digital output signal.

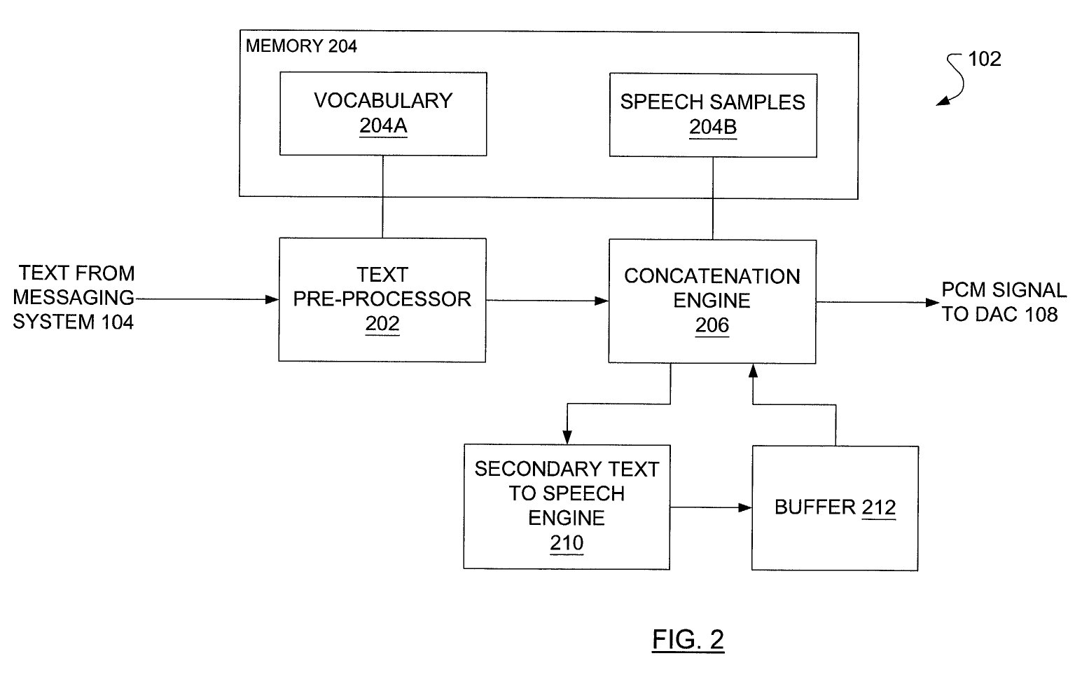

Turning to FIG. 2, the components of text to speech engine 102 (FIG. 1) are illustrated. Specifically, text is received by a text pre-processor 202. Textual units (root words, prefixes, suffixes), pauses and punctuation are identified by text pre-processor 202 and output to a concatenation engine 206. Text pre-processor 202 also references memory 204 and adds indicators to identified words based on whether or not they are in vocabulary 204A of memory 204 prior to output of the word. Concatenation engine 206 processes the output of text pre-processor 202 into speech units which are concatenated into a signal that may be output as a digital representation of an audio signal. To do so, concatenation engine 206 maintains a connection to speech samples 204B, in memory 204, corresponding to words in vocabulary 204A. Concatenation engine 206 also maintains a connection to a secondary text to speech engine 208 which converts, to speech units, any words in the received text that are outside the vocabulary stored in memory 204. The speech units output from secondary text to speech engine 208 are passed to concatenation engine 206 where they are concatenated to the other speech units in the output signal as appropriate.

In preparing a text to speech system according to an embodiment of the present invention, a “voice talent” speaks a set of utterances, typically whole words. Initially, the set of utterances must be decided upon and used to create a “script” to be recorded by the voice talent.

The set of utterances for a language of interest may include a set of root words, and a set of prefixes and suffixes. In a preferred embodiment, a set of root words is created by analysing a large volume of e-mail messages to determine a set of words that occur frequently in e-mail messages (2300 frequently used words were found experimentally). This set may be enhanced by creating a union of the determined set with a set of frequently used words in the language. This union creates a set of root words. The set of prefixes and suffixes includes those found, through the analysis, to occur frequently in the volume of e-mail messages. A union of the set of root words and the set of prefixes and suffixes forms a “vocabulary”. Memory 204 stores this “vocabulary” 204A as text and the corresponding “speech samples” 204B.

All of the root words in the vocabulary are sorted by the number of letters. Root words that are one letter long are stored in a first array, words that are two letters long are stored in a second array, . . . , words that are 13 letters long are stored in a thirteenth array, and words that are more than 13 letters long are stored in a fourteenth array. A fifteenth array is used to store all prefixes, and a sixteenth array is used to store all suffixes.

To provide a natural sounding voice, some variation in pitch is required in the set of utterances recorded by the voice talent. A characteristic of many languages (including English and French) is that most people speak within a range of two tones, a “root” tone and a higher tone, with the higher tone being used to impart an emphasis on some words. In English, the root tone and the higher tone often have the same interval as “doh” and “re” do on the musical scale (doh re me fa so la ti doh). In French, the root tone and the higher tone often have the same interval as “doh” and “so” on the musical scale. Before the voice talent is required to speak a “recording script”, a determination should be made as to which words should be spoken in the lower tone and which should be spoken in the higher tone, a very simple rule may be used. According to the rule, words with suffixes or prefixes are flagged as being more likely to benefit from emphasis than words that do not have prefixes or suffixes. This rule requires two sets of root words into two parts, one recorded in the lower tone and one recorded in the higher tone. The recording script may be generated by randomly choosing words from the set of root words. The script may be made up of “sentences”, each sentence comprising 16 words in an alternating pattern of four low tone words and four high tone words.

To ensure that the speech units sound natural, recordings for prefixes and suffixes may be extracted from recordings of words that used these prefixes and suffixes. Combinations of suffixes may be recorded in order to reduce the number of concatenations required to generate speech units, thus improving the speech quality. For example, the word “realisations” may be created by concatenating a speech sample of the root word “real” with a speech sample of the combined suffix “isations”.

All recordings may then be parsed into speech samples of root words, prefixes or suffixes. The speech samples may then be normalised and stored in μ-Law format with a polarity such that the largest peaks have positive values. The μ-Law format is a form of logarithmic quantization wherein more quantization levels are assigned to low signal levels than to high signal levels. Note that ITU (International Telecommunications Union) standard G.711, which encompasses both μ-Law and A-Law encoding of PCM signals, may be used for normalising speech samples. Alternatively, encoding formats such as 16-bit linear PCM or ITU standard G.726 ADPCM (adaptive differential PCM) may be used if desired.

Turning to FIG. 2, in operation, a text file (say, an e-mail message) is received by text pre-processor 202 where the text file is parsed into textual units (prefixes, root words and suffixes) and a list of textual units, pauses and punctuation is sent to concatenation engine 206. More specifically, text pre-processor 202 breaks up the text file into sentences, and then into words (using textual delimiters, such as spaces, punctuation, etc.). Special case words, such as words starting with http://, three to five letter words that are in upper case (i.e. acronyms), numbers and dates, are identified. Special procedures may be called to generate a list of words that correspond to special cases, which are added to the list of words to pass to the concatenation engine. For example, “1999” in a date may be passed to concatenation engine 206 as “nineteen ninety nine” as opposed to “one thousand nine hundred and ninety nine”.

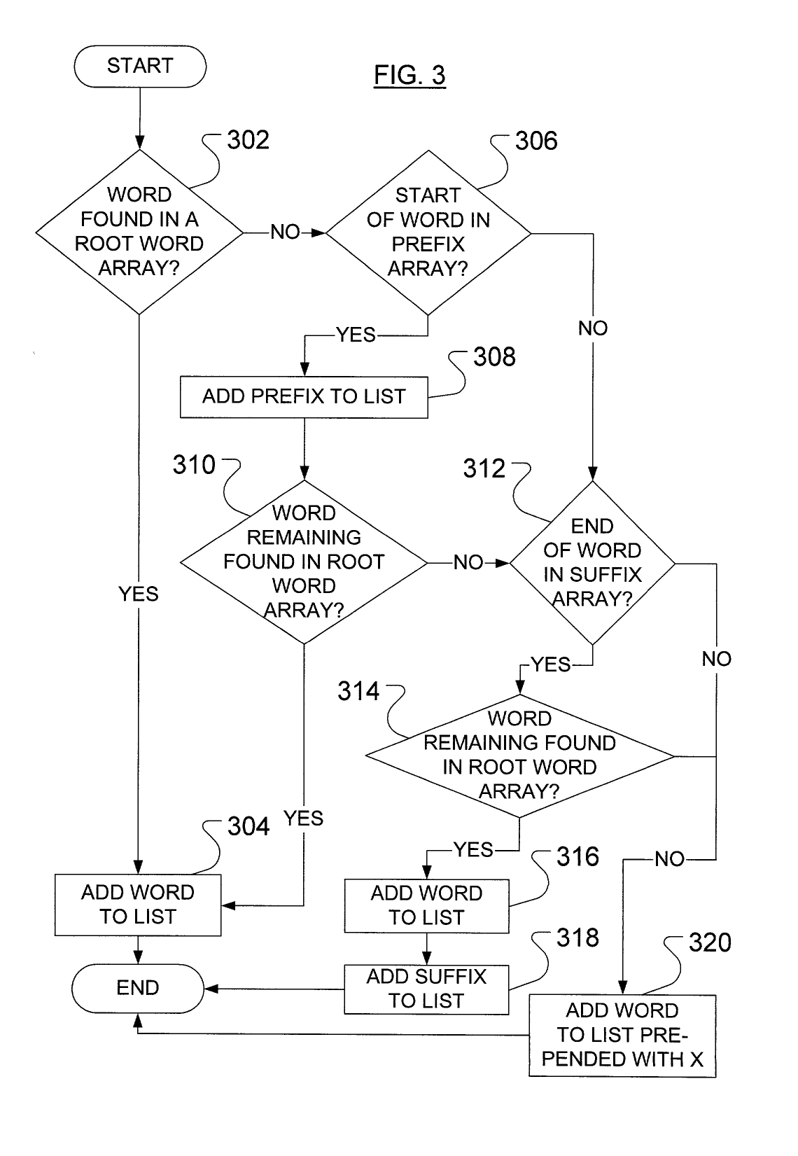

The addition of words to the list passed to concatenation engine 206 may be discussed in conjunction with FIG. 3. The length of the word is used to identify an appropriate root word array to search for the word, assuming no prefixes and suffixes. The appropriate array is then searched in vocabulary 204A of memory 204. If it is determined (step 302) that the word is present, the word is added to the list of words to pass to the concatenation engine (step 304). If the word is not present, the start of the word is examined (step 306) for a match with a prefixes from the prefix array. If a match is found in the prefix array, the prefix is added to the list (step 308) and an appropriate root word array is searched for the remainder of the word. If the remainder of the word is found (step 310) in a root word array, then the root word is added to the list of words to pass to the concatenation engine (step 304). If the remainder of the word is not found in a root word array, then the ending of the word is compared to the various entries in the suffixes array (step 312). If a match is found in the suffix array (step 314), the remainder (i.e. the middle part of the word) is sought in a length appropriate root word array. If the remainder is found in a root word array, the root word is added to the list (step 316) along with an indication that a suffix will follow. Subsequently, the root word and suffix are added to the list of words to pass to the concatenation engine (step 318). If no matches have been found, the word may be flagged as “out of vocabulary” by pre-pending an “x” to the word and adding the new word to the list of words to pass to the concatenation engine (step 320). Punctuation may be inserted into the list of words using special codes. If a match is found for only a prefix or suffix but not the root word, the whole word may be flagged as “out of vocabulary”.

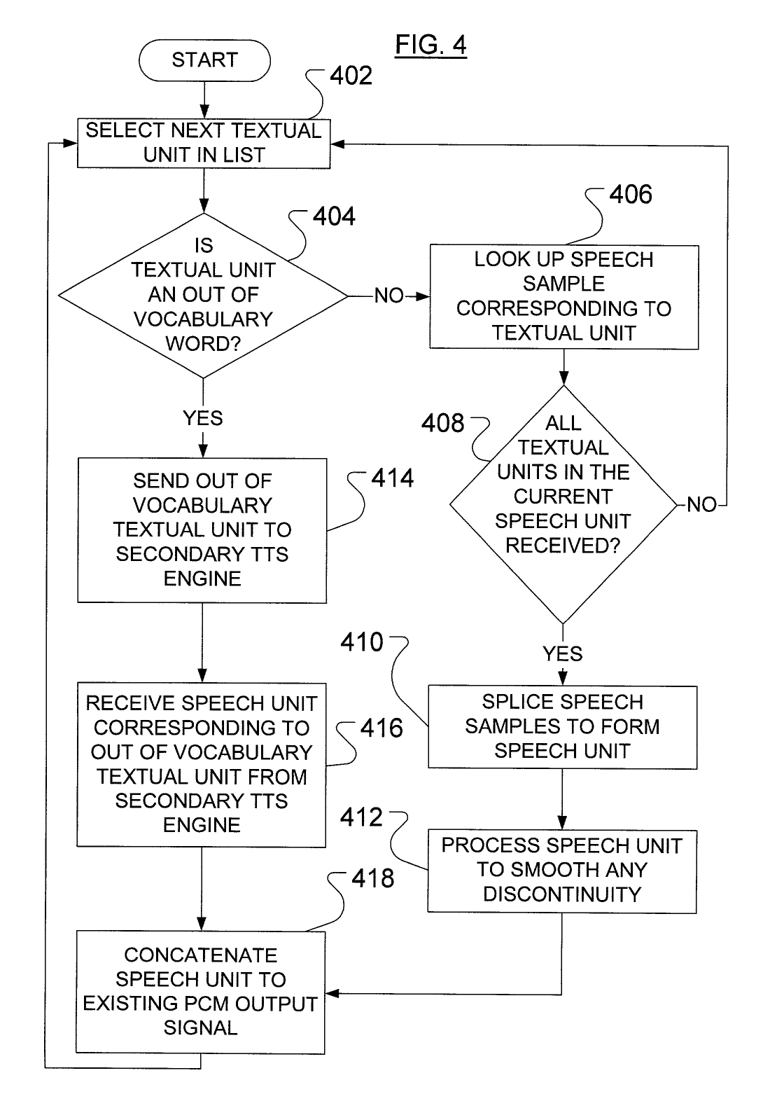

Concatenation engine 206 (FIG. 2) receives a list of textual units from text pre-processor 202 (FIG. 2) and builds up PCM output. Turning to FIG. 4, the method steps performed by concatenation engine 206 (FIG. 2) are illustrated. Textual units in the list received from text pre-processor 202 (FIG. 2) are considered one at a time. A textual unit is selected (step 402) and examined for a pre-processing indication of an out of vocabulary word (step 404). If the textual unit is determined to be in the vocabulary, a speech sample corresponding to the textual unit is located (step 406) in speech sample database 204B (FIG. 2). If it is determined (step 408) that a current speech unit is incomplete (i.e. a root word for which a suffix is the next textual unit in the list), the next textual unit in the list is selected (step 402). Otherwise, speech samples comprising the current speech unit are spliced together (step 410) and processed to smooth any discontinuity (step 412). Lastly, the current speech unit is concatenated to the PCM output (step 418). If the textual unit is determined to be an out of vocabulary word (step 404), the out of vocabulary indication (“x”) is stripped from the textual unit and the textual unit is passed to a secondary text to speech engine which stores its output (a speech sample of the textual unit) in a memory buffer 212. The contents of memory buffer 212 is then treated by concatenation engine 206 like a speech sample of a root word. After receiving the speech unit corresponding to the out of vocabulary word (step 416), the speech unit is concatenated with the preceding PCM output (step 418).

A number of algorithms may be used to join the prefixes and suffixes to the words to form speech units (step 410) and to join the speech units together to form sentences (step 418). These algorithms may be used to eliminate or reduce discontinuities between adjacent pre-recorded speech samples in amplitude, phase and pitch. Preferably, much of the processing involved with these algorithms is done when the speech samples are compiled and, as such, do not have to be implemented in real-time by the text to speech algorithm. This pre-processing of speech samples allows this text to speech technique to be computationally efficient.

To maintain a natural sound in the output signal, several techniques are used. The speech samples are spliced together at zero crossings. The gain of spliced speech samples is ramped so that the peaks on either side of the splice have the same amplitude. The pitch of the latter half of a preceding speech sample and the pitch of the first half of a following speech sample are adjusted so that they meet with a common pitch. The pitch adjustments may be performed using re-sampling techniques similar to those used in music synthesis. After the pitch adjustment, the speech samples may be re-spliced at zero crossings that follow positive valued major peaks.

Splicing techniques vary according to the type of sounds that are being spliced. For this reason, it is important that the text to speech engine be aware of the type of phoneme at the beginning and end of an utterance. Phoneme types include “vowel”, “voiced fricative” (e.g. v, z, th in that, j in judge), “unvoiced fricative” (e.g. f, s, th in with), “voiced stop” (e.g. b, d, g), “unvoiced stop” (e.g. p, t, k), “nasal and lateral” (e.g. m, n, l) and “trills and flaps” (e.g. r). A fricative is a consonant sound made by friction of breath in a narrow opening. Other algorithms may be used for joining fricatives together, ensuring that beginning and trailing plosives (e.g. t, k) are not lost in the concatenation, etc.

Special cases may be made for sh and ch since they affect the vowels around them somewhat differently than other unvoiced/voiced fricatives. In examples like “wishes” and “reaches”, the es ending has the e pronounced, while for “wished” and “reached”, the ed ending does not have the e pronounced, as opposed to “generated” where the e in ed is pronounced.

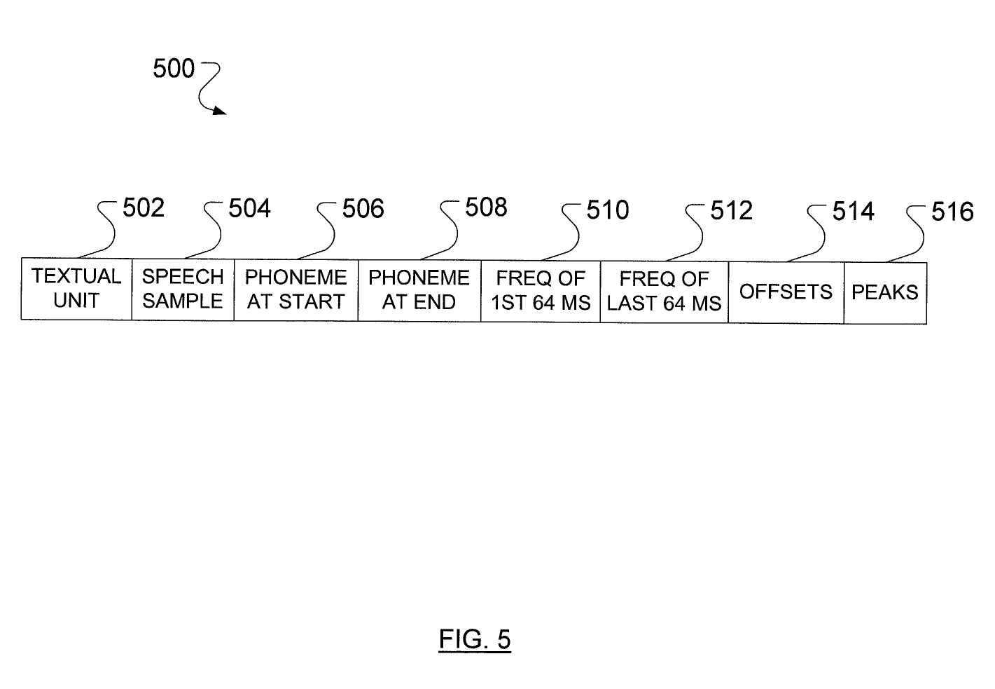

The above splicing techniques may be facilitated by pre-processing each speech sample and storing the resulting information, associated with the textual unit that corresponds to the speech sample. An exemplary data structure 500 for a particular textual unit is illustrated in FIG. 5. Associated in data structure 500 with a textual unit (field 502) representative of an utterance may be: a speech sample (field 504); the type of phoneme that the utterance starts with (field 506); the type of phoneme that the utterance ends with (field 508); the frequency of the first 64 ms of the utterance that exceeds an amplitude threshold of −20 dB (field 510); the frequency of the last 64 milliseconds of the utterance that exceeds an amplitude threshold of −20 dB (field 512); offsets from the beginning of the utterance to each zero crossing that follows a positive valued major peak in the first 64 milliseconds of the utterance for utterances that start with a voiced phoneme (field 514); offsets from the end of the utterance to each zero crossing that follows a positive valued major peak in the last 64 ms of the utterance for utterances that end with a voiced phoneme (field 514); and peak values that are associated with each of the above zero crossings (field 516). Contents of many of the above fields are useful in conventional splicing techniques.

An advantage of using whole words is that there is no need for a pronunciation dictionary, as the speech sample (recorded utterance) captures the correct pronunciation of the word. The text pre-processor can thus be simplified somewhat, and just has to parse prefixes and suffixes from the words in the text and pass the list of prefixes/words/suffixes to the concatenation engine for processing. Further, the invention requires 10-20 MB of memory but very little CPU, making it ideal for multi-channel implementations such as voice messaging servers.

As such a text to speech engine may be directed to an e-mail messaging environment, the vocabulary may be enhanced to recognise some standard methods of short hand notation. For instance, BTW is often used instead of “by the way” and IMHO is used in place of “in my humble opinion”. Where a conventional text to speech engine would likely pronounce the letters, the present invention may convert the letters into the appropriate spoken phrase. Similarly, punctuation in e-mail is often used to express an emotion. Such punctuation may be called an “emoticon” or a “smiley”. In converting an e-mail to speech, the present invention may express these emotions by, for example, converting “:-)” to a recording of laughter.

As will be apparent to a person skilled in the art, secondary TTS engine 208 (FIG. 2) may be the TTS3000 from Lernout & Hauspie Speech Products N.V. of Ypres, Belgium, or a phonetic text to speech engine based on the voice talent.

While the “out of vocabulary” words have been described as marked with an “x”, they may equally be indicated to be “out of vocabulary” in any other conventional manner (such as by, for example, marking only “in vocabulary” words, so that unmarked words are considered to be “out of vocabulary”).

Other modifications will be apparent to those skilled in the art and, therefore, the invention is defined in the claims.

We claim:

1. A method of converting text to speech comprising:
receiving a list of textual units, where each said textual unit is one of a word, a prefix or a suffix;
for each textual unit,
locating an associated speech sample in a memory; and
appending said associated speech sample to an output signal.

2. The method of claim 1 wherein one said textual unit in said list is indicated as not having an associated speech sample in memory and said method further comprises:
passing said indicated textual unit to a secondary text to speech engine;
receiving a speech sample converted from said indicated textual unit from said secondary text to speech engine; and
appending said converted speech sample to said output signal.

3. The method of claim 2 wherein each said speech sample in said memory comprises a processed recording of a voice talent and said secondary text to speech engine comprises a phonetic text to speech engine based on said voice talent.

4. The method of claim 1 wherein a consecutive plurality of said textual units in said list represent a whole word, said method further comprising:
for each textual unit in said consecutive plurality of said textual units, locating an associated speech sample in said memory;
creating a speech unit by splicing together said plurality of associated speech samples; and
appending said speech unit to said output signal.

5. The method of claim 4 further comprising, after said splicing, processing said speech unit to remove discontinuities.

6. A method of pre-processing a text file comprising:
receiving a text file;
parsing said text file into textual units, where each said parsed textual unit is one of a word, a prefix or a suffix; and
for each one of said parsed textual units, if said one of said parsed textual units corresponds to a stored textual unit in a vocabulary of textual units, adding said stored textual unit to a list.

7. The method of claim 6 further comprising, for each one of said parsed textual units, if said one of said parsed textual units does not correspond to one of said stored textual units,
marking said parsed textual unit as being out of vocabulary; and
adding said marked textual unit to said list.

8. The method of claim 7 where said marking comprises pre-pending a character to said textual unit.

9. A text to speech converter comprising:
means for receiving a list of textual units, where each said textual unit is one of a word, a prefix or a suffix;
for each textual unit,
means for locating an associated speech sample in a memory; and
means for appending said associated speech sample to an output signal.

10. A text to speech converter comprising a processor operable to:
receive a list of textual units, where each said textual unit is one of a word, a prefix or a suffix;
for each textual unit,
locate an associated speech sample in a memory; and
append said associated speech sample to an output signal.

11. A computer readable medium for providing program control to a processor, said processor included in a text to speech converter, said computer readable medium adapting said processor to be operable to:
receive a list of textual units, where each said textual unit is one of a word, a prefix or a suffix;
for each textual unit,
locate an associated speech sample in a memory; and
append said associated speech sample to an output signal.

12. A text to speech conversion system comprising:
a text file pre-processor operable to:
receive a text file;
parse said text file into textual units, where each said parsed textual unit is one of a word, a prefix or a suffix; and
for each one of said parsed textual units, if said one of said parsed textual units corresponds to a stored textual unit in a vocabulary of textual units, add said stored textual unit to a list;
and a textual unit processor operable to:
receive said list of textual units, where each said textual unit is one of a word, a prefix or a suffix;
for each textual unit, of said list:
locate an associated speech sample in a memory; and
append said associated speech sample to an output signal.

13. A computer data signal embodied in a carrier wave comprising a textual unit and a speech sample associated with said textual unit, where said textual unit is one of a word, a prefix or a suffix.

14. A data structure including a field for a textual unit and a field for a speech sample associated with said textual unit, where said textual unit is one of a word, a prefix or a suffix.
